(19) United States
(12) Patent Application Publication
(10) Pub. No.: US 2015/0026842 A1
(43) Pub. Date: Jan. 22, 2015

(54) METHOD OF CONTROLLING SUDDEN DEATH SYNDROME WITH FLUTRIAFOL

(71) Applicant: CHEMINOVA A/S, Harboore (DK)

(72) Inventors: James BARRENTINE, Fayetteville, AR (US); Andy BAILEY, Nottingham (GB)

(73) Assignee: CHEMINOVA A/S, Harboore (DK)

(21) Appl. No.: 14/332,865

(22) Filed: Jul. 16, 2014

(30) Foreign Application Priority Data
Jul. 17, 2013 (DK) PA 2013 70405

(51) Int. Cl. A01N 43/653; C05G 3/02

(52) U.S. Cl. CPC A01N 43/653; C05G 3/02
USPC 800/298; 548/267.8; 514/383; 504/101; 504/100

(57) ABSTRACT

This invention relates to the use of the compound flutriafol for protecting plants and plant propagation material from Sudden Death Syndrome. The use comprises applying a composition comprising flutriafol to the soil from which the plant propagation material, a plant, part of a plant and/or plant organ grow or grows at a later point in time.

### FIELD OF THE INVENTION

The present invention relates to the use of the compound flutriafol for protecting plants and plant propagation material from Sudden Death Syndrome, which leads to higher yields, better grade, and improved harvest efficiency.

### BACKGROUND

A severe threat to cultivated and wild plants, especially soybeans, is a root disease commonly known as Sudden Death Syndrome (SDS). The causative agent of SDS in North America is the fungus Fusarium virguliforme formerly known as Fusarium solani f. sp. glycines. The causative agents of SDS in South America are the fungi Fusarium virguliforme, Fusarium brasiliense, Fusarium cuneirostrum, and Fusarium tucumaniae. The fungi was first observed in 1971 in Arkansas, but has spread throughout most of the North Central Region of the United 15 States of America, but has also been reported in Brazil and Argentina. The fungi Fusarium virguliforme, Fusarium brasiliense, Fusarium cuneirostrum, and Fusarium tucumaniae are reported to be soil, seed and stubble borne pathogens, although they are primarily a root inhibiting fungi.

The fungi may infect roots of the seedlings soon after planting, but the above ground symptoms of SDS appear when the plants has reached the reproductive stages. The fungi penetrate into the vascular tissue of the plant, and the toxins produced by the fungi in the roots, are translocated to the leaves. Above ground, early symptoms of SDS are diffuse chlorotic mottling and crinkling of the leaves. Later, leaf tissue between the major veins turns yellow, then dies and turns brown. Soon after, the leaflets die and shrivel. In severe cases, the leaflets will drop off, leaving the petioles attached. For diagnosis of SDS, the lower stem and root must be split. The cortical tissue of a plant with SDS will exhibit tan to light brown streaks, whereas the cortex of a healthy plant will be white. The pith (the central portion of the stem) of an infected plant will remain white or slightly cream-colored. The SDS pathogens survive between susceptible crops as chlamydospores in crop residue or freely in the soil. Chlamydospores can withstand wide fluctuations in soil temperature, including freezing, and resist desiccation. As soil warms in the spring, chlamydospores near susceptible plant roots are stimulated to germinate, and then infect susceptible plant roots.

It has been observed that SDS is more severe in soybeans, when the soybean cyst nematode (SCN, Heterodera glycines) is also present in the field and the cultivar is susceptible to both pathogens.

The ability to control sudden death syndrome is very limited. The causative agents Fusarium virguliforme, Fusarium brasiliense, Fusarium cuneirostrum, and Fusarium tucumaniae can survive in the soil for several years, planting rotational crops is therefore not a good defence against these pathogens. Susceptible plant varieties less sensitive to SDS have been developed, but these varieties may still be infected by SDS. Planting these varieties in soils which are highly contaminated with SDS must therefore be avoided. In cool wet soils, young plants are most vulnerable to infection, and the best defence against these fungi is field management. Soil drainage and avoiding early planting of the plants is therefore crucial to limit the outbreak of SDS. Previously, chemical control has not been successful due to good survival ability of the chlamydospores.

A successful method for controlling one or more causative agents selected among the fungi Fusarium virguliforme, Fusarium brasiliense, Fusarium cuneirostrum, and Fusarium tucumaniae for the control of sudden death syndrome is therefore highly needed.

### SUMMARY OF THE INVENTION

It has now surprisingly and unexpectedly been found that the fungicidal active compound flutriafol shows a remarkably prolonged effect in the control of Sudden Death Syndrome.

Accordingly, this invention relates to the use of flutriafol for controlling the causative agent of Sudden Death Syndrome in a plant propagation material, a plant, part of a plant and/or plant organ, which comprises applying a composition comprising flutriafol to the soil from which the plant propagation material, a plant, part of a plant and/or plant organ grow or grows at a later point in time.

### DESCRIPTION OF THE INVENTION

One aspect of the invention relates to the use of flutriafol for controlling (i.e. controlling or preventing) the causative agent of Sudden Death Syndrome (SDS) in a plant propagation material, a plant, part of a plant and/or plant organ. The use comprises applying a composition comprising flutriafol to the soil from which the plant propagation material, a plant, part of a plant and/or plant organ grow or grows at a later point in time.

A second aspect of the invention relates to a method of controlling or preventing the causative agent of Sudden Death Syndrome (SDS) in a plant propagation material, a plant, part of a plant and/or plant organ which comprises applying a composition comprising flutriafol to the soil from which the plant propagation material, a plant, part of a plant and/or plant organ grow or grows at a later point in time.

Flutriafol, a well-known fungicidally active compound, is a member of the triazole group of fungicides. The IUPAC name of flutriafol is (RS)-2,4′-difluoro-α-(1H-1,2,4-triazol-1-ylmethyl)benzhydryl alcohol. The chemical structure of the compound is reproduced below:

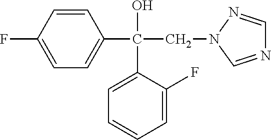 [SMILES: OC(Cn1cncn1)(c1ccc(F)cc1)c1ccccc1F]

Flutriafol is sold commercially as a fungicide by Cheminova under the trade names TOPGUARD®, Impact® and Vincit®.

Flutriafol, is systemic with long lasting residual activity and can therefore effectively be used to protect plants, at any point during the growth season, from a SDS causative agent of the following fungi Fusarium virguliforme (formerly Fusarium solani f. sp. glycine), Fusarium brasiliense, Fusarium cuneirostrum, and Fusarium tucumaniae. Without being bound by theory, flutriafol has a dual effect against SDS due to both its persistence in the soil providing a zone of control around the seed, developing root and developing seedling by contact action with the fungi but also as the root develops flutriafol is efficiently taken up by the developing root system both protecting the roots and young developing seedling from infection. If the soil and temperature conditions are conducive, the first 3-4 weeks of the life of a plant is a critical time to prevent the disease from entering the plant. The flutriafol protective effect will last throughout that critical period of infection from seedling to plant. In addition the systemicity will allow flutriafol to move further up the vascular system of the plant, potentially protecting it from any proliferation of disease in the growing stem. Flutriafol may also be applied as foliar application (e.g. sprayed directly on the foliage).

As used herein, a plant includes all known plants susceptible of being infected by SDS and all known plant varieties, including genetically modified plants. The term “plant propagation material” is understood to denote all the generative parts of the plant, such as seeds, which can be used for the multiplication of the latter and vegetative plant materials such as cuttings and tubers (for example, potatoes). Accordingly, as used herein, part of a plant includes plant propagation material. There may be mentioned, e.g., the seeds (in the strict sense), roots, fruits, tubers, bulbs, rhizomes, parts of plants. Germinated plants and young plants, which are to be transplanted after germination or after emergence from the soil, may also be mentioned. These young plants may be protected before/at transplantation by a total or partial treatment by immersion. Parts of plant and plant organs that grow or grows at later point in time are any sections of a plant that develop from a plant propagation material, such as a seed. Parts of plant, plant organs, and plants can also benefit from the protection achieved by the application of flutriafol onto the plant propagation material. In an embodiment, certain parts of a plant and certain plant organs that grow or grows at later point in time can also be considered as plant propagation material, which can themselves be applied (or treated) with flutriafol; and consequently, the plant, further parts of the plant and further plant organs that develop from the treated parts of plant and treated plant organs can also benefit from the pathogenic and/or pest damage protection achieved by the application of flutriafol on to the certain parts of plant and certain plant organs. A plant seed includes all known plants seeds susceptible of being infected by SDS and all known seed varieties/hybrids, including genetically modified seeds.

Using the flutriafol composition, it is possible to control SDS that occur in plants, especially, in cultivated plants and ornamentals, in horticulture and in forestry, or in parts of such plants such as fruit, blossoms, leaves, stems, tubers or roots, while in some cases parts of plants that grow later can also be protected against the pathogenic fungi.

The flutriafol composition can be used with advantage for controlling SDS in Amaranthaceae such as sugar beet; Brassicas such as canola, broccoli, brussels sprouts, cauliflower, cabbage, rape, mustard; Leguminosae such as mung beans, beans, lentils, peas, soybeans, groundnuts, chick peas, cowpea, lupin, clover, white clover, grasses, vetch, alfalfa; Poaceae such as wheat, ryegrass, corn, and sorghum; Preferably, the crop is selected among soybeans, alfalfa, beans, canola, sugar beet, clover, pea, vetch, corn, sorghum, wheat, and ryegrass.

The use of flutriafol as well as the application methods according to the invention for the protection of plants include applying the flutriafol composition in the soil in close proximity to the roots of the plant. The application methods according to the invention for the protection of plant propagation material against attack by SDS are characterized in that, for example, the composition is applied in such a manner that it is applied in close spatial proximity to, or spatially together with, planting or sowing the plant propagation material to the site of planting or sowing. Application of the composition in close spatial proximity to planting or sowing the plant propagation material to the site of planting or sowing takes place in accordance with the invention, preferably prior to planting or sowing the plant propagation material, by applying the compositions by soil application directly to the site where the plant propagation material has been planted or sown, for example preferably prior to sowing into the seed furrow or to a closely delimited area around the site of planting or sowing the plant propagation material. In addition, flutriafol will create a zone of protection in the soil, which controls the fungi in the soil, but also the roots, when contacted with the soil containing the composition, absorb the composition, and then distribute the composition throughout the plant through known means.

Preferred application methods are

(A) Preemergence or postemergence application.
i. Preemergence refers to application of the flutriafol composition before the plants have emerged from the soil.
ii. Postemergence refers to application of the flutriafol composition after the plant have emerged from the soil. For example the flutriafol composition is sprayed directly at the stem base, leaves, or soil interface of the plants;

(B) In-furrow application.
i. T-band application wherein the flutriafol composition is added before the furrow is closed, but after the plant propagation material is added to the opened furrow; or after the furrow has been closed.
ii. Modified in-furrow application wherein a plant propagation material is placed in an open furrow and the flutriafol composition is added such that it surrounds the plant propagation material, but minimizes the contact with the plant propagation material;
iii. granular application, either on fertilizer or a solid carrier applied in-furrow or potentially on side of furrow;

(C) Band spray application, wherein the flutriafol composition is sprayed onto the soil before
i. planting the plant propagation material; or
ii. planting the plant propagation material, and also incorporated the flutriafol composition into the soil;

(D) Irrigation either by
i. drip
ii. trickle on demand systems; or
iii. higher volume chemigation systems.

The invention also relates to a plant propagation material, a plant, part of a plant and/or plant organ that has been treated with flutriafol for the protection against a SDS causative agent, especially a plant propagation material, a plant, part of a plant and/or plant organ that has been treated with flutriafol for the protection against a SDS causative agent through soil application as herein described. The causative agent is e.g. one or more of the following fungi Fusarium virguliforme (formerly Fusarium solani f. sp. glycine), Fusarium brasiliense, Fusarium cuneirostrum, and Fusarium tucumaniae. The plant propagation material, a plant, part of a plant and/or plant organ can be treated in accordance with any of the uses and applications methods described herein using any composition comprising flutriafol, e.g. as those described herein.

As used herein, an amount of the composition effective to provide protection to the plant propagation material or the plant against damage caused by fungi is the lowest amount of flutriafol that will provide such protection. Accordingly, an effective amount of flutriafol, i.e. a fungicidal effective amount, is an amount sufficient to provide adequate disease control. An adequate amount is not easily defined, since it depends on various conditions, such as method of application, the type or size of plant or plant propagation material to be protected, and climate condition at time of application. However, as a general guideline when applied to the soil from which the plant propagation material or the plant grows, the flutriafol composition may be applied in an amount of 25 or more, 50 or more, 100 gram flutriafol per hectare or more; or the flutriafol composition may be applied in an amount of 800 or less, 700 or less, 600 gram flutriafol per hectare or less; preferably in an amount ranging from about 25 to about 800 gram flutriafol per hectare of cultivation area (g/ha), more preferred from about 50 to about 600 g/ha, even more preferred from about 100 to 400 g/ha and most preferred from about 125 to 300 g/ha.

The composition comprising flutriafol may also contain one or more fertilizers or nutrients to promote growth of the plant propagation material or plant once planted. The fertilizers may be mixed or incorporated into the composition comprising flutriafol, used with the flutriafol composition as a separate component, or used independently of the flutriafol composition in a separate application on the soil. Suitable fertilizers include organic and inorganic nitrogen-comprising compounds such as urea, urea-formaldehyde condensation products, amino acids, ammonium salts and nitrates; potassium salts (preferably chlorides, sulphates, nitrates); and phosphoric acid and/or salts of phosphoric acids (preferably potassium salts and ammonium salts). The fertilizers may also contain salts of micronutrients (preferably manganese, magnesium, iron, boron, copper, zinc, molybdenum and cobalt) and phytohormones (e.g. vitamin B1 and indole-III-acetic acid). The amount of fertilizer used is generally dependent on the crop, soil type, nutritional requirement, and crop rotation. The use of fertilizers in the composition may also serve to impregnate/absorb the flutriafol to create solid fertilizer carrier material, e.g. fertilizer granules comprising the flutriafol. Generally, when used in this manner, the fertilizer compositions comprising the flutriafol should contain from 0.0001 to 95% by weight flutriafol, preferably 0.1 to 90%.

The flutriafol composition may optionally contain additional fungicides, herbicides, bactericides, acaricides, nematicides or insecticides. Like the fertilizers, the additional fungicides, bactericides, acaricides, nematicides, and insecticides may be mixed or incorporated into the composition comprising flutriafol, used with the flutriafol composition as a separate component, or used independently of the flutriafol composition in a separate application on the soil. Suitable examples of additional fungicides are e.g.

A) azoles, in particular: azaconazole, bitertanol, bromuconazole, cyproconazole, difenoconazole, diniconazole, enilconazole, epoxiconazole, fluquinconazole, fenbuconazole, flusilazole, hexaconazole, imibenconazole, ipconazole, metconazole, myclobutanil, oxpoconazole, penconazole, propiconazole, prothioconazole, pyrisoxazole, simeconazole, triadimefon, triadimenol, tebuconazole, tetraconazole, triticonazole; prochloraz, pefurazoate, imazalil, triflumizole, cyazofamid; benomyl, carbendazim, thiabendazole, fuberidazole, ethaboxam, etridiazole, hymexazole;

B) strobilurins, in particular: azoxystrobin, benzothiostrobin, coumethoxystrobin, coumoxystrobin, enoxastrobin, dimoxystrobin, fenaminstrobin, flufenoxystrobin, enestroburin, fluoxastrobin, kresoxim-methyl, mandestrobin, metominostrobin, orysastrobin, picoxystrobin, pyraclostrobin, pyriminostrobin, pyrametostrobin, trifloxystrobin, triclopyricarb, pyraoxystrobin, fenamidone, famoxadone, or pyribencarb;

C) carboxamides, in particular: carboxin, benalaxyl, benodanil, boscalid, fenfuram, fenhexamid, fenpyrazamine, flutolanil, furalaxyl, furametpyr, isofetamid, isotranil, kiralaxyl, mepronil, metalaxyl, mefenoxam, ofurace, oxadixyl, oxycarboxin, penthiopyrad, pyrimorph, thifluzamide, tiadinil, bixafen, dimethomorph, flumorph, flumetover, fluopicolide (picobenzamid), zoxamide, carpropamid, diclocymet, mandipropamid, isopyrazam, fluxapyroxad, sedaxane, penflufen, fluopyram;

D) heterocylic compounds, in particular: benzovindiflupyr, isofetamid, fluazinam, pyrifenox, bupirimate, cyprodinil, fenarimol, ferimzone, mepanipyrim, nuarimol, pyrimethanil, triforine, fenpiclonil, fludioxonil, aldimorph, chloozolinate, dimethirimol, dodemorph, ethirimol, fenpropimorph, tridemorph, fenpropidin, iprodione, piperalin. procymidone, vinclozolin, famoxadone, fenamidone, octhilinone, probenazole, pyrisoxazole, amisulbrom, anilazine, diclomezine, pyroquilon, proquinazid, tricyclazole, acibenzolar-S-methyl, captafol, captan, dazomet, folpet, fenoxanil, quinoxyfen;

E) carbamates, in particular: mancozeb, maneb, metam, metiram, ferbam, propineb, thiram, zineb, ziram, benthiavalicarb, diethofencarb, iodocarb, iprovalicarb, flubenthiavalicarb, methasulfocarb, propamocarb, prothiocarb, pyributicarb, valifenalate; and

F) other active compounds, selected from guanidines: dodine, iminoctadine, guazatine, antibiotics: blasticidin-S, kasugamycin, streptomycin, oxytetracycline, polyoxin, validamycin; nitrophenyl derivates: binapacryl, dinocap, dinobuton, meptyldinocap; sulfur-containing heterocyclyl compounds: dithianon, isoprothiolane; organometal compounds: fentin salts, such as fentin-acetate, chloride or hydroxide; organophosphorus compounds: edifenphos, iprobenfos, fosetyl, fosetyl-AL, phosphorous acid and its salts, pyrazophos, tolclofos-methyl; organochlorine compounds: biphenyl, chloroneb, dicloran, chlorothalonil, dichlofluanid, flusulfamide, hexachlorobenzene, phthalide, pencycuron, quintozene, tecnazene, thiophanate-methyl, tolylfluanid; inorganic active compounds: Bordeaux mixture, copper acetate, copper hydroxide, copper oxychloride, basic copper sulfate, sulfur; others: cyflufenamid, cymoxanil, dimethirimol, ethirimol, metrafenone, flutianil, pyriofenone, bupirimate, oxathiapiprolin, benzovindiflupyr and spiroxamine;

G) Biological fungicides, in particular: Bacillus spp.: B. subtilis, B amyloliquefaciens; plant extracts: Melaleuca alternifolia.

Suitable examples of such additional herbicides are e.g.

1) from the group of the lipid biosynthesis inhibitors:

ACCase herbicides such as alloxydim, alloxydim-sodium, butroxydim, clethodim, clodinafop, clodinafop-propargyl, cycloxydim, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, pinoxaden, profoxydim, propaquizafop, quizalofop, quizalofop-ethyl, quizalofop-tefuryl, quizalofop-P, quizalofop-P-ethyl, quizalofop-P-tefuryl, sethoxydim, tepraloxydim and tralkoxydim; as well as non ACCase herbicides such as benfuresate, bensulide, butylate, cycloate, dalapon, dimepiperate, EPTC, esprocarb, ethofumesate, flupropanate, molinate, orbencarb, pebulate, prosulfocarb, TCA, thiobencarb, tiocarbazil, triallate and vernolate;

2) from the group of the ALS inhibitors:

sulfonylureas such as amidosulfuron, azimsulfuron, bensulfuron, bensulfuron-methyl, chlorimuron, chlorimuron-ethyl, chlorsulfuron, cinosulfuron, cyclosulfamuron, ethametsulfuron, ethametsulfuron-methyl, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, iodosulfuron, iodosulfuron-methyl-sodium, mesosulfuron, metsulfuron, metsulfuron-methyl, nicosulfuron, orthosulfamuron, oxasulfuron, primisulfuron, primisulfuron-methyl, prosulfuron, pyrazosulfuron, pyrazosulfuron-ethyl, rimsulfuron, sulfometuron, sulfometuron-methyl, sulfosulfuron, thifensulfuron, thifensulfuron-methyl, triasulfuron, tribenuron, tribenuron-methyl, trifloxysulfuron, triflusulfuron, triflusulfuron-methyl and tritosulfuron; imidazolinones such as imazamethabenz, imazamethabenz-methyl, imazamox, imazapic, imazapyr, imazaquin and imazethapyr, triazolopyrimidine herbicides and sulfonanilides such as cloransulam, cloransulam-methyl, diclosulam, flumetsulam, florasulam, metosulam, penoxsulam, pyrimisulfan and pyroxsulam; pyrimdinylbenzoates such as bispyribac, bispyribac-sodium, pyribenzoxim, pyriftalid, pyriminobac, pyriminobac-methyl, pyrithiobac, pyrithiobac-sodium; and also sulfonylaminocarbonyl-triazolinone herbicides such as flucarbazone, flucarbazone-sodium, propoxycarbazone, propoxycarbazone-sodium, thiencarbazone and thiencarbazone-methyl.

5, 6, 7) from the group of the photosynthesis inhibitors:

photosystem II inhibitors, for example, including triazine, triazinone, triazolinone, pyridazinone herbicides such as ametryn, amicarbazone, atrazine, chloridazone, cyanazine, desmetryn, dimethametryn, hexazinone, metamitron, metribuzin, prometon, prometryn, propazine, simazine, simetryn, terbumeton, terbuthylazine, terbutryn and trietazine; urea herbicides such as chlorobromuron, chlorotoluron, chloroxuron, dimefuron, diuron, fluometuron, isoproturon, isouron, linuron, metamitron, methabenzthiazuron, metobenzuron, metoxuron, monolinuron, neburon, siduron, tebuthiuron and thidiazuron; phenyl carbamates such as desmedipham, karbutilate, phenmedipham, phenmedipham-ethyl; nitrile herbicides such as bromofenoxim, bromoxynil and its salts and esters, ioxynil and its salts and esters; uracils such as bromacil, lenacil and terbacil, as well as bentazone and bentazone-sodium, pyridate, pyridafol, pentanochlor and propanil, and photosystems I inhibitors such as diquat, diquat-dibromide, paraquat, paraquat-dichloride and paraquat-dimetilsulfate.

14) from the group of the protoporphyrinogen oxidase inhibitors: acifluorfen, acifluorfen-sodium, azafenidin, bencarbazone, benzfendizone, bifenox, butafenacil, carfentrazone, carfentrazone-ethyl, chlomethoxyfen, cinidon-ethyl, fluazolate, flufenpyr, flufenpyr-ethyl, flumiclorac, flumiclorac-pentyl, flumioxazin, fluoroglycofen, fluoroglycofen-ethyl, fluthiacet, fluthiacet-methyl, fomesafen, halosafen, lactofen, oxadiargyl, oxadiazon, oxyfluorfen, pentoxazone, profluazol, pyraclonil, pyraflufen, pyraflufen-ethyl, sulfentrazone, thidiazimin, saflufenacil;

11, 12, 13, 27) from the group of the bleacher herbicides:

PDS-inhibitors: beflubutamid, diflufenican, fluridone, fluorochloridone, flurtamone, norflurazon, picolinafen and 4-(3-trifluoromethylphenoxy)-2-(4-trifluoromethylphenyl)pyrimidine (CAS 180608-33-7), HPPD-inhibitors: benzobicyclon, benzocenap, isoxachlortole, isoxaflutole, mesotrione, pyrasulfotole, pyrazolynate, pyrazoxyfen, sulcotrione, tefuryltrione, tembotrione, topramezone, bicyclopyrone, bleachers, unknown target: aclonifen, amitrol and clomazone;

9) from the group of the EPSP synthase inhibitors:

glyphosate, glyphosate-isopropylammonium and glyphosate-trimesium (sulfosate), glyphosate-potassium; glyphosate-sodium, glyphosate-ammonium;

10) from the group of the glutamine synthase inhibitors:

bilanaphos (bialaphos), bilanaphos-sodium, glufosinate and glufosinate-ammonium; 18) from the group of the DHP synthase inhibitors:

asulam;

3, 23) from the group of the mitosis inhibitors:

compounds of dinitroanilines, such as benfluralin, butralin, dinitramine, ethalfluralin, fluchloralin, oryzalin, pendimethalin, prodiamine and trifluralin; phosphoramidates, such as amiprophos, amiprophos-methyl and butamiphos; benzoic acids such as chlorthal, chlorthal-dimethyl; pyridines, such as dithiopyr and thiazopyr; benzamides, such as propyzamide and tebutam; carbmates: chlorpropham, propham and carbetamide.

15) from the group of the VLCFA inhibitors:

chloroacetamides such as acetochlor, alachlor, butachlor, dimethachlor, dimethanamid, dimethenamid-P, metazachlor, metolachlor, metolachlor-S, pethoxamid, pretilachlor, propachlor, propisochlor and thenylchlor;

oxyacetanilides, such as flufenacet and mefenacet; acetamides such as diphenamid, naproanilide and napropamide; tetrazolinones, such as fentrazamide, and

others, such as anilofos, cafenstrol, piperophos and pyroxasulfone.

20, 21, 26) from the group of the cellulose biosynthesis inhibitors:

chlorthiamid, dichlobenil, flupoxam and isoxaben;

24) from the group of the decoupler herbicides:

dinoseb, dinoterb and DNOC and its salts;

4) from the group of the auxin herbicides:

2,4-D and its salts and esters, 2,4-DB and its salts and esters, aminocyclopyrachlor and its salts and esters, aminopyralid and its salts such as aminopyralid-tris(2-hydroxypropyl)ammonium and its esters, benazolin, benazolin-ethyl, choramben and its salts and esters, clomeprop, clopyralid dicamba and its salts and esters, dichlorprop and its salts and esters, dichlorprop-P and its salts and esters, fluroxypyr, MCPA and its salts and esters, MCPA-thioethyl, MCPB and its salts and esters, mecoprop and its salts and esters, mecoprop-P and its salts and esters, picloram, quinclorac, quinmerac, triclopyr TBA (2,3,6) and its salts and esters;

19) from the group of the auxin transport inhibitors: diflufenzopyr, diflufenzopyr-sodium, naptalam and naptalam-sodium;

17, 25, 26) from the group of the other herbicides: bromobutide, chloroflurenol, chloroflurenol-methyl, cinmethylin, cumyluron, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-M-methyl, flurenol, flurenol-butyl, flurprimidol, fosamine, fosamine-ammonium, indanofan, maleic hydrazide, mefluidide, metam, methyl azide, methyl bromide, methyl-dymron, methyl iodide, MSMA, oleic acid, oxaziclomefone, pelargonic acid, pyributicarb, quinoclamine, triaziflam, fenquinotrione, cyclopyrimorate, mevalocidin, fenoxasulfone, iofensulfuron, herbimycin, halauxifen, halauxifen-methyl, tiafenacil, and tridiphane.

Additional, safeners may also be added to the composition, suitable safeners are e.g.: benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, oxabetrinil, 4-(dichloroacetyl)-1-oxa-4-azaspiro[4,5]decane (AD 67, CAS nr. 71526-07-3), 4-carboxy-3,4-dihydro-2H-1-benzopyran-4-acetic acid (CL 304,415, CAS nr. 31541-57-8), 2,2-dichloro-N-[2-oxo-2-(2-propenylamino)ethyl]-N-2-propenylacetamide (DKA-24, CAS nr. 97454-00-7), 2-dichloromethyl-2-methyl-1,3-dioxolane (MG 191, CAS nr. 22052-63-7), 3-(dichloroacetyl)-2,2,5-trimethyl-1,3-oxazolidine (RD 29148, CAS nr. 52836-31-4), and 1-dichloroacetylazepane (TI-35, CAS nr. 64661-12-7).

Sudden Death Syndrome has been observed to be more severe when the soybean cyst nematode (SCN, Heterodera glycines) is present in a field and the cultivar is susceptible to both pathogens. Flutriafol may therefore advantageously be combined with an insecticide, nematicide or acaricide, preferably a nematicide. Suitable examples of insecticides, nematicides and acaricides are e.g.:

abamectin, acequinocyl, acephate, acetamiprid, acrinathrin, afidopyraben, alanycarb, albendazole, aldicarb, allethrin, alpha-cypermethrin, aluminium phosphide, amitraz, azadirachtin, azamethiphos, azinphos-ethyl, azocyclotin, Bacillus finnus, Bacillus sphaericus, Bacillusthuringiensis (including susp.), bendiocarb, benfuracarb, bensultap, benzoximate, bephenium, betacyfluthrin, beta-cypermethrin, bifenazate, bifenthrin, bioallethrin, bioallethrin S-cyclopentenyl isomer, bioresmethrin, bistrifluron, borax, BPMC, brofenprox, bromophos, bromopropylate, brotianide, bufencarb, buprofezin, butamisole, butocarboxim, butoxycarboxim, butylpyridaben, cadusafos, calcium phosphide, cambendazole, carbaryl, carbofuran, carbophenothion, carbosulfan, cartap hydrochloride chinomethionat, chloethocarb, chlorantraniliprole, chlordane, chlorfenapyr, chloroethoxyfos, chlorofenvinphos, chlorofluazuron, chloromephos, chloropicrin, chlorpyrifos, chlorpyrifos-methyl, chromafenozide, cis-resmethrin, clocythrin, clofentezine, clorsulon, closantel, clothianidin, cryolite, coumaphos, cyanide, cyantraniliprole, cyanophos, cyclaniliprole, cycloprothrin, cyenopyrafen, cyflumetofen, cyfluthrin, cyhalothrin, cyhexatin, cypermethrin, cyphenothrin, cyromazine, d-cis-trans allethrin, deltamethrin, DDT, demeton-S-methyl, diafenthiuron, diamphenethide, dibromosalan, dichlorophen, 1,3-dichloroprene, difenthiuron, diazinon, dichlofenthion, dichlorvos, dicliphos, dicofol, dicrotophos, diethion, diethylcarbamazine, diflovidazin, diflubenzuron, dimethoate, dimethyl disulphide, dimethylvinphos, dinotefuran, dioxathion, disulfoton, DNOC, d-trans allethrin, edifenphos, endosulfan, emamectin(-benzoate), empenthrin, EPN, epsiprantel, esfenvalerate, ethiofencarb, ethion, ethiprole, ethofenprox, ethoprop, ethoprophos, etoxazole, etrimphos, famphur, febantel, fenamiphos, fenbendazole, fenazaquin, fenbutatin oxide, fenitrothion, fenobucarb, fenothiocarb, fenoxycarb, fenpropathrin, fenpyrad, fenpyroximate, fenthion, fenvalerate, fipronil, flometoquin, flonicamid, fluacrypyrim, fluazuron, flubendazole, flubendiamide, flucycloxuron, flucythrinate, flufenoxuron, flufenprox, flufiprole, flumethrin, fluopyram, fluvalinate, flupyradifurone, fonophos, formetanate, formothion, fosthiazate, fubfenprox, furathiocarb, furfural, gamma-cyhalothrin, halfenprox, halofenozide, haloxon, heptafluthrin, heptenophos, Heterorhabtlitis bacteriophora, hexaflumuron, hexachlorophene, hexythiazox, hydramethylnon, hydroprene, imicyafos, imidacloprid, imiprothrin, indoxacarb, iprobenfos, isazophos, isofenphos, isoprocarb, isopropyl-O-salicylate, isoxathion, ivermectin, kadethrin, kinoprene, lambda-cyhalothrin, lepimectin, levamisole, lufenuron, malathion, mebendazole, mecarbam, mevinphos, mesulfenphos, metaflumizone, metaldehyde, metam sodium, metam potassium, methacrifos, methamidophos, methidathion, methiocarb, methomyl, methoxychlor, methoxyfenozide, methyl bromide, methyridine, metolcarb, mevinphos, milbemectin, momfluorothrin, monocrotophos, morantel, Myrothecium verrucaria strains naled, netobimin, niclopholan, niclosamide, nicotine, nitenpyram, nitroxynil, novaluron, noviflumuron, omethoate, oxamyl, oxfendazole, oxibendazole, oxyclozanide, oxydemethon-M, oxydeprofos, parathion A, parathion M, parbendazol, Pasteuria spp., permethrin, phenothiazine, phenothrin, phenthoate, phorate, phosalone, phosmet, phosphorodithioate, phosphamidon, phosphine, phoxim, piperonyl butoxide, pirimicarb, pirimiphos-methyl, prallethrin, praziquantel, profenofos, promecarb, propargite, propaphos, propetamphos, propoxur, prothiofos, prothoate, pyflubumide, pymetrozine, pyrachlophos, pyrantel, pyridalyl, pyridaphenthion, pyresmethrin, pyrethrum, pyridaben, pyrimidifen, pyriproxyfen, quinalphos, rafoxanide, resmethrin, rotenone, dioxabenzophos (salithion), Saponins of Quillaja saponaria, sebufos, silafluofen, spinosad, spinetoram, spirodiclofen, spiromesifen, spirotetratmat, Steinernema scapterisci strains, Steinemema feltiae, Steninernema kraussei, sulfotep, sulfoxaflor, sulfuramid, sulfuryl floride, sulprofos, tasmanone, tatar emetic, tau-fluvalinate, tebufenozide, tebufenpyrad, tebupirimiphos, teflubenzuron, tefluthrin, temephos, terbam, terbufos, tetradifon, tetra-chlorvinphos, tetramethrin, tetramisole, thenium, theta-cypermethrin, thiabendazole, thiacloprid, thiafenox, thiamethoxam, thiocyclam, thiodicarb, thiofanox, thiomethon, thionazin, thiophanate, thiosultap-sodium, thuringiensin, tolfenpyrad, tralomethrin, transfluthrin, triarathen, triazamate, triazophos, triazuron, trichlorfon, triclabendazole, triflumuron, trimethacarb, vamidothion, XMC, xylylcarb, zeta-cypermethrin, zinc phosphide.

In a preferred embodiment of the present invention one or more of the following fungicides, insecticides, nematicides, herbicides, fertilizer and/or inoculant is applied together with the flutriafol: imidacloprid, thiamethoxam, clothianidin, fipronil, atrazine, acetochlor (and respective safener), S-metachlor (and respective safener), pethoxamid, sulfentrazone, mesotrione, dicamba, 2,4-D, glyphosate, pendimethalin, chloropicrin, fomesafen, saflufenacil, flufenacet, isoxaflutole (and respective safener), fludioxonil, ipconazole, tebuconazole, azoxystrobin, pyraclostrobin, mefenoxam, metalaxyl, thiophanate-methyl, thiram, fluazinam, abamectin, Bacillus spp., Pasteuria spp., fertilizer (10-34-0, 18-46-0, 7-21-7, 8-32-16) and inoculants (Bradyrhizobium spp., Rhizobium spp.).

In an embodiment of the present invention, flutriafol is the sole active fungicidal/pesticidal compound applied in the uses and methods herein described and/or present in the compositions as herein described and the use thereof. Accordingly, one aspect of the invention relates to the use of flutriafol for controlling or preventing pathogenic damage caused by the fungi Macrophomina phaseolina in a plant propagation material, a plant, part of a plant and/or plant organ that grow or grows at a later point in time, by applying a composition containing flutriafol (i.e. as the sole active fungicidal/pesticidal ingredient) on the plant, part of the plant, plant organ, plant propagation material or a surrounding area thereof; as well as another aspect of the invention that relates to a a method of controlling or preventing pathogenic damage caused by the fungi M. phaseolina in a plant propagation material, a plant, part of a plant and/or plant organ that grow or grows at a later point in time, which comprises applying on the plant, part of the plant, plant organ, plant propagation material or a surrounding area thereof a composition containing flutriafol (i.e. as the sole active fungicidal/pesticidal ingredient).

The composition comprising flutriafol may be applied as any type of agrochemically acceptable composition. The composition may be in a liquid form, such as an emulsifiable concentrate, a dispersion, a suspension concentrate, or aqueous emulsion; in a solid form, such as powders, dusts, pellets, or granules; or in a paste, wettable powder, or water-dispersible granules. Generally, it is preferred that when the composition is applied to the soil from which the plant and/or seed grows, it is applied as a liquid, solid or granulate composition. However, these preferences lie in the convenience of application, and no disadvantage is seen from applying the composition in another agrochemically acceptable form.

The composition will usually comprise 0.1 to 99%, preferably 0.1 to 95%, of flutriafol, and 1 to 99.9%, preferably 5 to 99.9%, of at least one solid or liquid carrier; usually they will contain 0.1 to 50%, preferably 0.1 to 20%, of surfactants (in each case percentages are by weight). Whereas commercial products will preferably be formulated as concentrates, the end user will normally employ dilute formulations having a substantially lower concentration of active ingredient. Particularly preferred formulations will be made up as follows: (throughout, percentages are by weight):

Emulsifiable concentrates:

| | |
|---|---|
| Flutriafol: | 1 to 99%, preferably 60 to 90% |
| Surfactant: | 1 to 30%, preferably 1 to 20% |
| Solvent: | 1 to 80%, preferably 1 to 35% |

Dusts:

| | |
|---|---|
| Flutriafol: | 0.1 to 90%, preferably 1 to 80% |
| Solid carrier: | 1 to 99.9%, preferably 15 to 90% |

Suspension concentrates:

| | |
|---|---|
| Flutriafol: | 5 to 75%, preferably 10 to 50% |
| Water: | 24 to 94%, preferably 30 to 88% |
| Surfactant: | 1 to 40%, preferably 2 to 30% |

Suspo-emulsion

| | |
|---|---|
| Flutriafol: | 1 to 99%, preferably 10 to 50% |
| Surfactant: | 1 to 30%, preferably 1 to 20% |
| Solvent: | 1 to 80%, preferably 1 to 35% |

Wettable powders:

| | |
|---|---|
| Flutriafol: | 0.1 to 90%, preferably 1 to 80% |
| Surfactant: | 1 to 50%, preferably 1 to 15% |
| Solid carrier: | 1 to 95%, preferably 15 to 90% |

Granulates:

| | |
|---|---|
| Flutriafol: | 0.1 to 90%, preferably 1 to 80% |
| Surfactant: | 1 to 50%, preferably 1 to 15% |
| Solid carrier: | 1 to 95%, preferably 15 to 90% |

The compositions of the invention can for example be formulated as follows:

1. Products for dilution with water.

A) Water-Soluble Concentrates (SL, LS)

10 parts by weight of the active compound(s) are dissolved in 90 parts by weight of water or a water-soluble solvent. As an alternative, wetters or other auxiliaries are added. The active compound(s) dissolve(s) upon dilution with water, whereby a formulation with 10% (w/w) of active compound(s) is obtained.

B) Dispersible Concentrates (DC)

20 parts by weight of the active compound(s) are dissolved in 70 parts by weight of cyclohexanone with addition of 10 parts by weight of a dispersant, for example polyvinylpyrrolidone. Dilution with water gives a dispersion, whereby a formulation with 20% (w/w) of active compound(s) is obtained.

C) Emulsifiable Concentrates (EC)

15 parts by weight of the active compound(s) are dissolved in 7 parts by weight of xylene with addition of calcium dodecylbenzenesulfonate and castor oil ethoxylate (in each case 5 parts by weight). Dilution with water gives an emulsion, whereby a formulation with 15% (w/w) of active compound(s) is obtained.

D) Emulsions (EW, EO, ES)

25 parts by weight of the active compound(s) are dissolved in 35 parts by weight of xylene with addition of calcium dodecylbenzenesulfonate and castor oil ethoxylate (in each case 5 parts by weight). This mixture is introduced into 30 parts by weight of water by means of an emulsifier machine (e.g. Ultraturrax) and made into a homogeneous emulsion. Dilution with water gives an emulsion, whereby a formulation with 25% (w/w) of active compound(s) is obtained.

E) Suspensions (SC, OD, FS)

In an agitated ball mill, 20 parts by weight of the active compound(s) are comminuted with addition of 10 parts by weight of dispersants, wetters and 70 parts by weight of water or of an organic solvent to give a fine active compound(s) suspension. Dilution with water gives a stable suspension of the active compound(s), whereby a formulation with 20% (w/w) of active compound(s) is obtained.

F) Water-Dispersible Granules and Water-Soluble Granules (WG, SG)

50 parts by weight of the active compound(s) are ground finely with addition of 50 parts by weight of dispersants and wetters and made as water-dispersible or water-soluble granules by means of technical appliances (for example extrusion, spray tower, fluidized bed). Dilution with water gives a stable dispersion or solution of the active compound(s), whereby a formulation with 50% (w/w) of active compound(s) is obtained.

G) Water-Dispersible Powders and Water-Soluble Powders (WP, SP, SS, WS)

75 parts by weight of the active compound(s) are ground in a rotor-stator mill with addition of 25 parts by weight of dispersants, wetters and silica gel. Dilution with water gives a stable dispersion or solution of the active compound(s), whereby a formulation with 75% (w/w) of active compound(s) is obtained.

H) Gel-Formulation (GF) In an agitated ball mill, 20 parts by weight of the active compound(s) are comminuted with addition of 10 parts by weight of dispersants, 1 part by weight of gelling agent wetters and 70 parts by weight of water or of an organic solvent to give a fine active compound) suspension. Dilution with water gives a stable suspension of the active compound(s), whereby a formulation with 20% (w/w) of active compound(s) is obtained.

I) Capsule Suspensions (CS)

28 parts of active compound(s), are mixed with 2 parts of an aromatic solvent and 7 parts of toluene diisocyanate/polymethylene-polyphenylisocyanate-mixture (8:1). This mixture is emulsified in a mixture of 1.2 parts of polyvinylalcohol, 0.05 parts of a defoamer and 51.6 parts of water until the desired particle size is achieved. To this emulsion a mixture of 2.8 parts 1,6-diaminohexane in 5.3 parts of water is added. The mixture is agitated until the polymerization reaction is completed. The obtained capsule suspension is stabilized by adding 0.25 parts of a thickener and 3 parts of a dispersing agent. The capsule suspension formulation contains 28% of the active ingredients. The medium capsule diameter is 3-10 microns.

2. Products to be Applied Undiluted.

J) Dustable Powders (DP, DS)

5 parts by weight of the active compound(s) are ground finely and mixed intimately with 95 parts by weight of finely divided kaolin. This gives a dustable product having 5% (w/w) of active compound(s).

K) Granules (GR, FG, GG, MG)

0.5 part by weight of the active compound(s) is ground finely and associated with 95.5 parts by weight of carriers, whereby a formulation with 0.5% (w/w) of active compound(s) is obtained. Current methods are extrusion, spray-drying or the fluidized bed. This gives granules to be applied undiluted.

L) ULV Solutions (UL)

10 parts by weight of the active compound(s) are dissolved in 90 parts by weight of an organic solvent, for example xylene. This gives a product having 10% (w/w) of active compound(s), which is applied undiluted.

Various types of oils, wetters, adjuvants, herbicides, fungicides, other pesticides, or bactericides may be added to the active ingredients, if appropriate just immediately prior to use (tank mix). These agents usually are admixed with the agents according to the invention in a weight ratio of 1:20 to 20:1.

Each of the combinations of the invention can be formulated for a particular use. Preferably, each combination is formulated for protecting cultivated plants or their plant propagation materials. Accordingly, each combination of the invention can be applied to the soil in a conventional manner, such as foliar spray. Advantageously, each of the combinations are formulated for plant propagation material treatment applications for controlling or preventing damage caused by SDS, which can particularly damage the plant in the early stages of its development.

To prepare emulsions, pastes or oil dispersions, the flutriafol composition can be homogenized in water or dissolved in an oil or solvent by means of wetting agents, adhesives, dispersants or emulsifiers, as known in the art. Concentrates comprising flutriafol, wetting agent, adhesive, dispersant or emulsifier, and possibly solvent or oil can also be prepared which are suitable for dilution with water. Powder, scattering, and dusting compositions may be prepared by mixing or joint grinding the flutriafol with a solid carrier.

Granules, for example coated, impregnated and homogeneous granules, may be prepared by binding flutriafol to solid carriers through known methods. Solid carriers include mineral earths, such as silica gel, silicic acids, silicates, talc, kaolin, limestone, lime, chalk, bole, loess, clay, dolomite, diatomaceous earth, calcium sulfate and magnesium sulfate, magnesium oxide, ground synthetic materials, fertilizers, such as ammonium sulfate, ammonium phosphate, ammonium nitrate, ureas and vegetable products, such as cereal flour, tree bark meal, wood meal and nutshell meal, and cellulose powder.

The composition comprising flutriafol may be prepared in any known manner, such as with solvents, carriers, penetrating agents, emulsifiers, dispersants, soil surfactants, surface-active agents, or a combination thereof. Suitable solvents include aromatics (e.g. xylene), chlorinated aromatics (e.g. chloroben-zenes), paraffins (e.g. petroleum fractions), alcohols (e.g. methanol, butanol), ketones (e.g. cyclohexanone), amines (e.g., ethanolamine, dimethylformamide) and water. If water is used as a diluent, other organic solvents may be used as the solvents. Suitable carriers include ground natural minerals (e.g. kaolins, aluminas, talc, chalk) and ground synthetic minerals (e.g. highly disperse silica, silicates). Suitable emulsifiers include nonionic and anionic emulsifiers (e.g. polyoxyethylene fatty alcohol ethers, alkylsulfonates and arylsulfonates). Suitable dispersants include lignin-sulfite waste liquors and methylcellulose. Suitable surface-active agents include alkali metals, alkaline earth metals, ammonium salts of aromatic sulfonic acids, (e.g. lignosulfonic, phenolsulfonic, naphthalenesulfonic and dibutylnaphthalenesulfonic acid), fatty acids, alkyl- and alkylarylsulfonates, alkyl-, lauryl ether and fatty alcohol sulfates, salts of sulfated hexa-, hepta- and octadecanols, fatty alcohol glycol ethers, condensation products of sulfonated naphthalene and its derivatives with formaldehyde, condensation products of naphthalene or of the naphthalenesulfonic acids with phenol and formaldehyde, polyoxyethylene octylphenol ether, ethoxylated isooctyl-, octyl- or nonylphenol, alkylphenol or tributyl-phenylpolyglycol ethers, alkylaryl polyether alcohols, isotridecyl alcohol, fatty alcohol ethylene oxide condensates, ethoxylated castor oil, polyoxyethylene or polyoxypropylenealkyl ethers, lauryl alcohol polyglycol ether acetate, sorbitol esters, lignin-sulfite waste liquors, or methylcellulose. Suitable soil surfactantsinclude tri-block copolymers, glucoethers (for example with the trade name Integrate 80), and non-ionic surfactants (for example with the trade name Integrate 20).

It may be useful to add one or more binders to the composition. Preferably, the binder is an adhesive polymer that may be natural or synthetic and does not produce a phytotoxic effect. Suitable binders include polyvinyl acetates; polyvinyl acetate copolymers; polyvinyl alcohols; polyvinyl alcohol copolymers; celluloses, including ethylcelluloses, methylcelluloses, hydroxymethylcelluloses, hydroxypropylcelluloses and carboxymethylcellulose; polyvinylpyrolidones; polysaccharides, including starch, modified starch, dextrins, maltodextrins, alginate and chitosans; fats; oils; proteins, including gelatin and zeins; gum arabics; shellacs; vinylidene chloride and vinylidene chloride copolymers; calcium lignosulfonates; acrylic copolymers; polyvinylacrylates; polyethylene oxide; acrylamide polymers and copolymers; polyhydroxyethyl acrylate, methylacrylamide monomers; and polychloroprene.

Optionally, also colorants can be included in the formulation. Suitable colorants or dyes are Rhodamin B, C.I. pigment Red 112, C.I. Solvent Red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

### EXAMPLES

### Example 1

Inhibition of Fusarium virguliforme was tested in the following example:

The flutriafol composition used in the example was TOPGUARD (125 g/L flutriafol SC). Each pathogen was grown out on fresh potato dextrose agar (commercial PDA), assessed and used to seed 2× autoclaved rice for inoculums development. At 7-10 days, two infested rice grains of each pathogen (2 per pathogen type) was placed at equal distances on flutriafol-amended PDA and incubated at 27-29° C. Mycelial colony diameter from each rice grain was measured at 1, 3, 5 and 7 days from grain placement. The included tables and data sets illustrate the differences in mycelia growth in response to various concentrations of the fungicide for one of the SDS pathogen types, Fusarium virguliforme.

TABLE 1
Inhibition of Fusarium virguliforme by flutriafol at 1, 3, 5 and 7 days.

| | | Dia (mm) | Dia (mm) | Dia (mm) | Dia (mm) |
|---|---|---|---|---|---|
| Treatment | Rate | 1 day | 3 days | 5 days | 7 days |
| 1. Untreated | n/a | 0 | 13.4 | 19.4 | 22.5 |
| 2. flutriafol | 250 ppm | 0 | 0 | 0 | 0 |
| 3. flutriafol | 100 ppm | 0 | 0 | 0 | 3 |
| 4. flutriafol | 10 ppm | 0 | 7.5 | 13.9 | 18.1 |
| 5. flutriafol | 1 ppm | 0 | 9.6 | 15.3 | 20 |
| 6. flutriafol | 0.1 ppm | 0 | 10.1 | 16.4 | 19.8 |
| 7. flutriafol | 0.01 ppm | 0 | 10.4 | 15.6 | 19.6 |

### Example 2

The determination of the efficacy and selectivity of flutriafol fungicide when applied pre-emergence to soybean for control of Sudden Death Syndrome (SDS) was tested in the following example:

The experiment was conducted in a Drummer silty clay loam soil with a pH of 6.8 and 3.0% organic matter. The experiment was set up as a randomized complete block with four replications. Plots were four 30 inch rows or a total of 10 ft. wide by 40 ft. long. Plot site was conventionally tilled and the trial was established on May 15, 2013, by planting NK S36-B6, a sudden death syndrome susceptible soybean variety. Seed was planted 1.5 inches deep and the seeding rate was 140,000 seeds/A. Topguard (a commercially available flutriafol SC formulation comprising 125 g/l) was applied at planting in-furrow in a 3-5 inch T-band perpendicular to the row with Teejet 4001E nozzles in a spray volume of 2 GPA. Topguard rates applied were 0.13, 0.195, 0.26 lb ai/acre (corresponding to 145.7, 218.6, 291.4 g ai/ha, respectively). These correspond to rates of 16, 24, or 32 fl oz of product/acre, respectively. One treatment of a 3-5 inch band of 32 fl oz/A Topguard was applied on May 21 as an ‘At Cracking’ application immediately prior to crop emergence. Trial was inoculated with SDS on sterile sorghum media that was applied in-furrow with a gandy box at planting at a rate of 25 ml per 20 ft of row. Data was collected from the two center rows from each plot.

Drip irrigation was installed so the trial had no moisture stress throughout the season. On August 12, 19 and 30, soybean sudden death syndrome (SDS) incidence (0-100%) and severity (0-9) were evaluated. An SDS disease index (SDS DX) was created by multiplying the % Incidence by the % Severity and dividing by 9. Soybeans were harvested on October 10 and yields were calculated and adjusted to bu/A at 13% moisture.

Flutriafol applied in a T-Band had numerically lower SDS Incidence and Disease Index scores on August 12 and August 19. On August 26, SDS incidence, severity and SDS disease index were the lowest with Topguard applied in-furrow at 24 fl oz/A. Flutriafol applied as a T-band at 16, 24 or 32 oz/A had a trend to higher soybean yield as compared to the ‘At Cracking’ application and the untreated check.

TABLE 2

| | | | R5.6 | | | R5.8 | | |
|---|---|---|---|---|---|---|---|---|
| | | | SDS 8/12 | | | SDS 8/19 | | |
| | | | 0-100% | 0-9 | inc*sev/9 | 0-100% | 0-9 | inc*sev/9 |
| Product | Rate | Timing | Inci. | Severity | SDS DX | Inci. | Severity | SDS DX |
| Topguard | 16 | At Planting | 5.5 | 1.3 | 0.9 | 22.5 | 1.5 | 3.8 |
| Topguard | 24 | At Planting | 5.5 | 1.3 | 1 | 16.3 | 1.5 | 3.1 |
| Topguard | 32 | At Planting | 13.8 | 1.6 | 2.7 | 28.8 | 1.4 | 4.9 |
| Topguard | 32 | At Cracking | 32.5 | 1.9 | 7.4 | 41.3 | 1.9 | 10.4 |
| Untreated | | | 30 | 1.8 | 6.6 | 46.3 | 2.1 | 12 |

| | | | R6.2 | | | |
|---|---|---|---|---|---|---|
| | | | SDS 8/30 | | | bu/A |
| | | | 0-100% | 0-9 | inc*sev/9 | (13%) |
| Product | Rate | Timing | Inci. | Severity | SDS DX | Yield |
| Topguard | 16 | At Planting | 50 | 4.9 | 27.5 | 49.3 |
| Topguard | 24 | At Planting | 37.5 | 4 | 17.4 | 48.8 |
| Topguard | 32 | At Planting | 56.3 | 5.3 | 32.8 | 47.7 |
| Topguard | 32 | At Cracking | 60 | 5.3 | 36.9 | 43.6 |
| Untreated | | | 42.5 | 6 | 30.6 | 41.2 |

1. Use of flutriafol for controlling the causative agent of Sudden Death Syndrome (SDS) in a plant propagation material, a plant, part of a plant and/or plant organ, which comprises applying a composition comprising flutriafol to the soil from which the plant propagation material, a plant, part of a plant and/or plant organ grow or grows at a later point in time.

2. The use according to claim 1, wherein the causative agent is one of the following fungi Fusarium virguliforme, Fusarium brasiliense, Fusarium cuneirostrum, and Fusarium tucumaniae.

3. The use according to claim 1, wherein the composition is applied as in-furrow application to the soil from which the plant propagation material, a plant, part of a plant and/or plant organ grow or grows at a later point in time.

4. The use according to claim 1, wherein the composition is applied in an amount ranging from about 25 to about 800 grams flutriafol per hectare.

5. The use according to claim 1, wherein the composition further comprises one or more fertilizers.

6. The use according to claim 1, wherein the use further comprises applying one or more fertilizers and/or soil surfactants to the soil.

7. The use according to claim 1, wherein the use further comprises applying one or more additional fungicides, insecticides and/or nematicides to the soil.

8. The use according to claim 1, wherein the composition further comprises one or more additional fungicides, insecticides and/or nematicides.

9. The use according to claim 1, wherein the plant is selected from the families of Amaranthaceae, Brassicas, Leguminosae, and Poaceae.

10. (canceled)

11. A method of controlling or preventing the causative agent of Sudden Death Syndrome (SDS) in a plant propagation material, a plant, part of a plant and/or plant organ which comprises applying a composition comprising flutriafol to the soil from which the plant propagation material, a plant, part of a plant and/or plant organ grow or grows at a later point in time.

12. The method according to claim 11, wherein the causative agent is one of the following fungi Fusarium virguliforme, Fusarium brasiliense, Fusarium cuneirostrum, and Fusarium tucumaniae.

13. The method according to claim 11, wherein the composition is applied as in-furrow application to the soil from which the plant propagation material, a plant, part of a plant and/or plant organ grow or grows at a later point in time.

14. The method according to claim 11, wherein the composition is applied in an amount ranging from about 25 to about 800 grams flutriafol per hectare.

15. The method according to claim 11, wherein the composition further comprises one or more fertilizers.

16. The method according to claim 11, wherein the method further comprises applying one or more fertilizers and/or soil surfactants to the soil.

17. The method according to claim 11, wherein the composition further comprises one or more additional fungicides, insecticides and/or nematicides.

18. The method according to claim 11, wherein the method further comprises applying one or more additional fungicides, insecticides and/or nematicides to the soil.

19. The method according to claim 11, wherein the plant is selected from the families of Amaranthaceae, Brassicas, Leguminosae, and Poaceae.

20. (canceled)

21. (canceled)

22. (canceled)
